(19) United States
(12) Patent Application Publication
(10) Pub. No.: US 2024/0186615 A1
(43) Pub. Date: Jun. 6, 2024

(54) BATTERY PACK

(71) Applicant: SAMSUNG SDI CO., LTD., Yongin-si (KR)

(72) Inventors: Jeehoon JEON, Yongin-si (KR); Taeho JI, Yongin-si (KR); Soodeok MOON, Yongin-si (KR); Soomin AHN, Yongin-si (KR); Jaelim RYU, Yongin-si (KR); Dongsik KWAK, Yongin-si (KR); Beomjun WOO, Yongin-si (KR)

(21) Appl. No.: 18/448,800

(22) Filed: Aug. 11, 2023

(30) Foreign Application Priority Data
Dec. 1, 2022 (KR) 10-2022-0165817

(51) Int. Cl. H01M 10/6556; H01M 10/613; H01M 10/6554; H01M 50/186; H01M 50/262; H01M 50/507

(52) U.S. Cl. CPC H01M 10/6556; H01M 10/613; H01M 10/6554; H01M 50/186; H01M 50/262; H01M 50/507

(57) ABSTRACT

A battery pack includes: a base plate having a first surface for supporting a plurality of battery modules and including a cooling passage configured to receive a refrigerant; a lower cover covering a second surface of the base plate; a frame portion on the first surface of the base plate and including a plurality of frames coupled to each other by a fastening member; a sealing member sealing spaces between the frames of the frame portion; and an upper cover covering an upper portion of the frame portion.

### CROSS-REFERENCE TO RELATED APPLICATION

This application claims priority to and the benefit of Korean Patent Application No. 10-2022-0165817, filed in the Korean Intellectual Property Office on Dec. 1, 2022, the entire content of which is incorporated herein by reference.

### BACKGROUND

### 1. Field

Aspects of embodiments of the present disclosure relate to a battery pack.

### 2. Description of the Related Art

Secondary batteries are widely used in mobile devices, auxiliary power devices, and the like.

In addition, secondary batteries are attracting attention as a primary power source for electric vehicles, hybrid electric vehicles, plug-in hybrid electric vehicles, and the like and are suggested as an alternative to solve various problems, such as air pollution from conventional gasoline vehicles or diesel vehicles.

A battery module in which a plurality of battery cells are stacked and

electrically connected to each other in series and parallel is used for electric vehicles, etc., due to a need for a high-output, large-capacity battery.

In the battery module, a plurality of battery cells are stacked, and terminals exposed at opposite ends of each of the battery cells are electrically connected to each other to provide high voltage.

For such a battery module, pack housings of various methods and sizes and of suitable shapes and pack capacity are being manufactured but, in many ways, a conventional battery module as its limitations, such as scalability, serviceability, and recycling.

That is, a conventional battery module design is not easily modified to change the energy capacity to be supplied, and a manufacturing efficiency is deteriorated.

The above information disclosed in this Background section is for enhancement of understanding of the background of the present disclosure, and therefore, it may contain information that does not form the prior art that is already known to a person of ordinary skill in the art.

### SUMMARY

An embodiment of the present disclosure provides a battery pack that simplifies a structure of a battery module by eliminating a welding process and prevents a risk of an electrical error by forming a cooling circuit at the outside.

An embodiment of the present disclosure includes: a base plate having a first surface for supporting a plurality of battery modules and including a cooling passage configured to receive a refrigerant; a lower cover covering a second surface of the base plate; a frame portion on the first surface of the base plate and including a plurality of frames coupled to each other by a fastening member; a sealing member sealing spaces between the frames of the frame portion; and an upper cover covering an upper portion of the frame portion.

The cooling passage may be on a second surface of the base plate that is opposite to the first surface of the base plate.

The base plate may include a plurality of cooling plates having edges that are welded to each other.

The base plate may further include: a first cooling plate having a second surface from which a first cooling passage protrudes; a second cooling plate having a first edge coupled to a first edge of the first cooling plate and a second surface from which a second cooling passage protrudes; and a third cooling plate having a first edge coupled to a second edge of the second cooling plate and a second surface from which a third cooling passage protrudes.

The first to third cooling passages may each be formed as a plurality in the first to third cooling plates, respectively.

The battery pack may further include a refrigerant supply guide at a first side of the second surface of the base plate to guide supply of the refrigerant to portions of the first cooling passage and the second cooling passage.

The refrigerant supply guide may be configured to supply the refrigerant to portions of the first cooling passage of the first cooling plate and the second cooling passage of the second cooling plate.

The refrigerant supply guide may extend in a width direction of the first cooling plate such that a portion thereof covers a portion of the second surface of the second cooling plate to supply the refrigerant to portions of the first cooling passage and the second cooling passage.

The refrigerant supply guide may include: a supply guide body extending in the width direction of the first cooling plate to cover portions of the first cooling plate and the second cooling plate to move a refrigerant therein; an inlet protrusion protruding from a first side of the supply guide body and through which the refrigerant flows; and a plurality of supply protrusions protruding from a second side of the supply guide body to supply the refrigerant to portions of the first cooling passage and the second cooling passage.

The battery pack may further include a distribution supply guide installed at a second side of the second surface of the base plate and configured to distribute the refrigerant supplied by the refrigerant supply guide.

The distribution supply guide may include: a distribution guide body extending in a width direction of the base plate from the second side of the second surface of the base plate to move the refrigerant therein; and a plurality of distribution protrusions protruding from a side surface of the distribution guide body to be connected to the first cooling passage, the second cooling passage, and the third cooling passage.

The battery pack may further include a refrigerant discharge guide connected to some of the first cooling passages of the first cooling plate and the third cooling passage of the third cooling plate to guide discharge of the refrigerant to the outside on the second surface of the base plate.

The refrigerant discharge guide may extend in a width direction of the first cooling plate such that a portion thereof covers a portion of the second surface of the second cooling plate to discharge and guide the refrigerant flowing through the third cooling passage and some of the second cooling passages to the outside.

The refrigerant discharge guide may include: a discharge guide body extending in a width direction of the third cooling plate such that a portion thereof covers a portion of the second surface of the second cooling plate to move the refrigerant therein; a connecting protrusion protruding from a first side of the discharge guide body and connected to some of the second cooling passages and the third cooling passage to receive the refrigerant; and a discharge protrusion protruding from a second side of the discharge guide body to discharge the refrigerant to the outside.

The sealing member may include: a first sealer in an inlet groove on any one surface between the frames; and a second sealer in a position of a fastening hole in at least one of the frames to allow the fastening member to be coupled thereto.

The first sealer may contact a side surface of the frames by allowing a first side to be inserted into the inlet groove and a second side to partially protrude out of the inlet groove.

The first sealer may have a linear shape in the inlet groove.

The first sealer may have a bent (or curved) portion that is bent to contact an upper surface of the frames at an upper end of the first sealer.

The bent portion of the first sealer may be adhered to the upper cover by an adhesive member.

The second sealer may have a through hole through which the fastening member extends to be inserted into the fastening hole at a position between the frames.

The second sealer may have a round shape inserted into the fastening hole.

The frame portion may include: a first side frame coupled to a first edge of the base plate; a second side frame coupled to a second edge of the base plate; a first end frame having opposite ends connected to a first end of each of the first side frame and the second side frame by a fastening member; a second end frame having opposite ends connected to a second end of each of the first side frame and the second side frame by a fastening member; a plurality of first reinforcement bars having a first end connected to a side surface of the first side frame by a fastening member and a second end connected to a side surface of the second side frame by a fastening member; and a plurality of second reinforcement bars having a first end connected to a side surface of the first end frame by a fastening member and a second end connected to the second end frame by a fastening member, the second reinforcement bars crossing the first reinforcement bars.

An adhesive groove may be in a lower surface of the frame portion, and an adhesive for fixing the base plate may be applied to the adhesive groove.

The battery pack may further include a plurality of battery modules. Each of the battery modules may include: a first side plate supporting a first side surface of a plurality of battery cells; a second side plate supporting a second side surface of the battery cells; a first end plate having opposite ends connected to a first end of each of the first side plate and the second side plate by a fastening member; a second end plate having opposite ends connected to a second end of each of the first side plate and the second side plate by a fastening member; an insulating plate having a first end connected to a side surface of the first end plate and a second end connected to a side surface of the second end plate and having an adhesive applied to opposite side surfaces of the battery cells; and an upper plate covering an upper portion of the battery cells.

A first coupling hole to which a first end of the insulating plate is fixed may be in a side surface of the first end plate, and a second coupling hole to which a second end of the insulating plate is fixed may be in a side surface of the second end plate.

The insulating plate may have a first end from which a first coupling protrusion that is inserted and fixed into a first coupling hole protrudes and a second end from which a second coupling protrusion that is inserted and fixed into the second coupling hole protrudes.

A surface of each of the first side plate and the second side plate in contact with the battery cells may be coated with an insulating material.

A first mount protrusion fixed to the upper cover by a fastening member may protrude from an upper edge of the first end plate.

A second mount protrusion fixed to the upper cover by a fastening member may protrude from an upper edge of the second end plate.

The upper plate may include: a plurality of bus bars installed to be electrically connected to terminals of the battery cells; and a gas tunnel portion formed between the bus bars in a longitudinal direction of the upper cover.

The battery pack may further include a plurality of battery modules. Each of the battery modules may include: a first side portion supporting a first side surface of a plurality of battery cells; a second side portion supporting a second side surface of the battery cells; a first end portion having opposite ends connected to a first end of each of the first side portion and the second side portion by a fastening member; a second end portion having opposite ends connected to a second end of each of the first side portion and the second side portion by a fastening member; and an insert bar inserted into the first side portion and the second side portion.

Terminals of the battery cells may face in a direction of the first side portion and the second side portion.

The first side portion and the second side portion may be made of a plastic material.

The first side portion may include: a first plate having a plurality of through holes into which terminals of the battery cells are inserted; and a first insert portion protruding from a side surface of the first plate and having an insertion hole into which the insert bar is inserted.

The first insert portion may be at a first edge position and a second edge position with the through hole provided therebetween in the first plate.

A bus bar electrically connected to the terminals extending through the through hole may be installed in the first side portion.

An adhesive may be between the first plate and the battery cells.

The second side portion may include: a second plate having a plurality of through holes into which terminals of the battery cells are inserted; and a second insert portion protruding from a side surface of the second plate and having an insertion hole into which the insert bar is inserted.

The second insert portion may be formed at a first edge position and a second edge position with the through hole provided therebetween in the second plate. A bus bar electrically connected to the terminal extending through the through hole may be in the second side portion.

An adhesive may be applied between the second plate and the battery cells.

According to embodiments of the present disclosure, the battery modules may be assembled to be disassemblable and assemblable by fastening of a fastening member instead of by using a welding process in an assembly process, and thus, a structure of the battery modules may be simplified and a design thereof may be easily changed.

According to embodiments of the present disclosure, a cooling circuit is formed outside the base plate supporting the battery module, and thus, an electrical flow path may not be generated during operation of the battery modules.

### BRIEF DESCRIPTION OF THE DRAWINGS

FIG. 1 illustrates a schematic perspective view of a battery pack according to an embodiment of the present disclosure.

FIG. 2 illustrates a schematic exploded perspective view of the battery pack shown in FIG. 1.

FIG. 3 illustrates a schematic perspective view of a base plate according to an embodiment of the present disclosure.

FIG. 4 illustrates a cross-sectional view taken along the line A-A of FIG. 3.

FIG. 5 illustrates an exploded perspective view of the base plate showing a state in which a refrigerant supply guide, a distribution supply guide, and a refrigerant discharge guide are separated from the base plate shown in FIG. 3.

FIG. 6 illustrates an exploded perspective view of the base plate showing a state in which the base plate shown in FIG. 3 is separated into first to third cooling plates.

FIG. 7 illustrates a schematic perspective view of a frame portion according to an embodiment of the present disclosure.

FIG. 8 illustrates an exploded perspective view of the frame portion shown in FIG. 7.

FIG. 9 illustrates an exploded perspective view inside a frame portion showing a state in which a sealing member is installed according to an embodiment of the present disclosure.

FIG. 10 schematically illustrates a bent portion that is formed at an upper portion of a first sealer of the sealing member shown in FIG. 9 to be fixed to an upper cover by an adhesive.

FIG. 11 illustrates an exploded perspective view of an adhesive groove in a frame portion showing a state in which an adhesive is applied to the adhesive groove according to an embodiment of the present disclosure.

FIG. 12 illustrates a schematic perspective view of a battery module according to an embodiment of the present disclosure.

FIG. 13 illustrates an exploded perspective view showing a state in which an upper plate of the battery module shown in FIG. 12 is separated.

FIG. 14 illustrates a perspective view of a state in which an upper plate of the battery module shown in FIG. 12 is removed.

FIG. 15 illustrates a schematic exploded perspective view of the battery module shown in FIG. 14.

FIG. 16 illustrates a schematic perspective view showing coupling of an insulating plate and a first end plate according to an embodiment of the present disclosure.

FIG. 17 illustrates a schematic perspective view of the insulating plate shown in FIG. 16.

FIG. 18 illustrates a state in which a gas tunnel portion is formed in the battery module according to an embodiment of the present disclosure.

FIG. 19 illustrates a schematic exploded perspective view of a battery module according to an embodiment of the present disclosure.

FIG. 20 illustrates a schematic perspective view of a first side portion shown in FIG. 19.

FIG. 21 illustrates a schematic side view of a state in which an insert bar of the battery module shown in FIG. 19 is installed.

### DETAILED DESCRIPTION

Hereinafter, the present disclosure will be described more fully with reference to the accompanying drawings, in which embodiments of the present disclosure are shown. As those skilled in the art would realize, the described embodiments may be modified in various different ways, all without departing from the spirit or scope of the present disclosure. Thus, the drawings and description are to be regarded as illustrative in nature and not restrictive.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

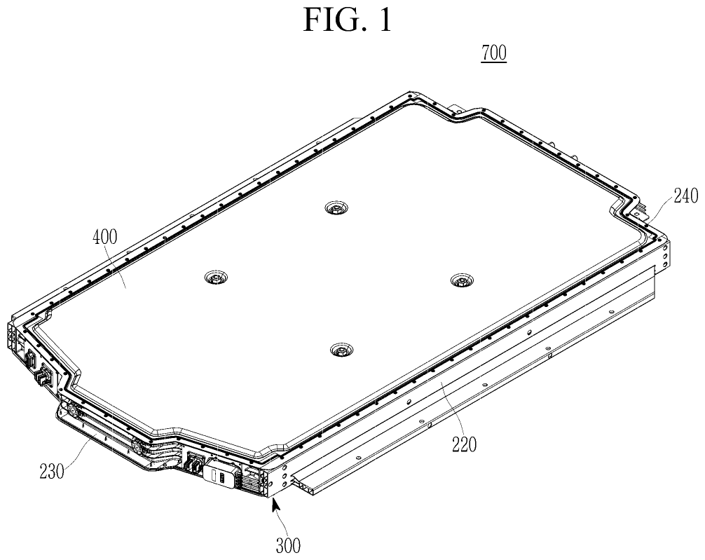

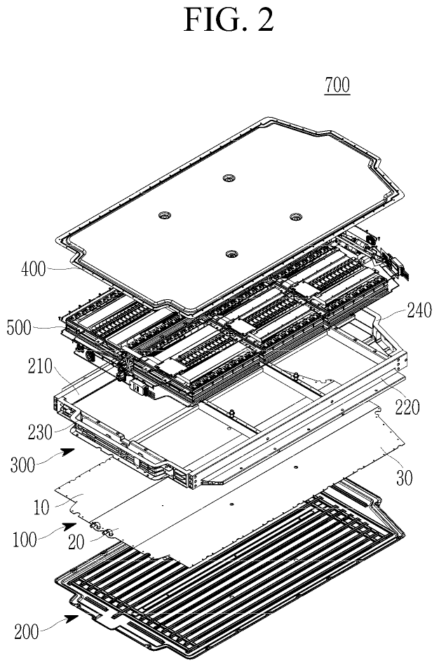

FIG. 1 illustrates a schematic perspective view of a battery pack according to an embodiment of the present disclosure, and FIG. 2 illustrates a schematic exploded perspective view of the battery pack shown in FIG. 1.

As illustrated in FIG. 1 and FIG. 2, according to an embodiment of the present disclosure, a battery pack 700 includes: a base plate 100 including a cooling passage in which a refrigerant for cooling a plurality of battery modules 500 circulates by contacting a first surface of the battery modules 500; a frame portion (e.g., a frame) 300 installed at an upper side (or upper surface) of the first surface of the base plate 100 and accommodating a plurality of battery modules 500 therein; and an upper cover 400 covering an upper portion (or upper side or surface) of the frame portion 300. The frame portion 300 may include a plurality of frames coupled to each other by a fastening member(s).

The base plate 100 may be installed to support lower portions of the battery modules 500 accommodated inside the frame portion 300. For example, the base plate 100 may be installed below the frame portion 300 to enable cooling of the first surface, which is an upper surface, of the base plate 100 to cool the battery modules 500 and to support the lower portions of the battery modules 500.

This base plate 100 may include at least two plates, to be installed in a state in which edges are coupled to each other.

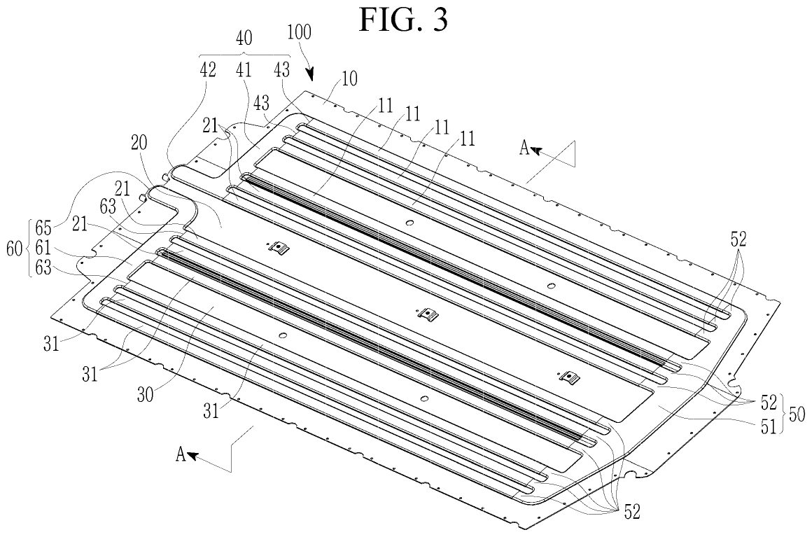

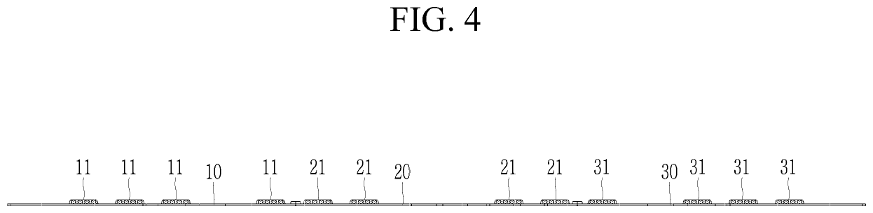

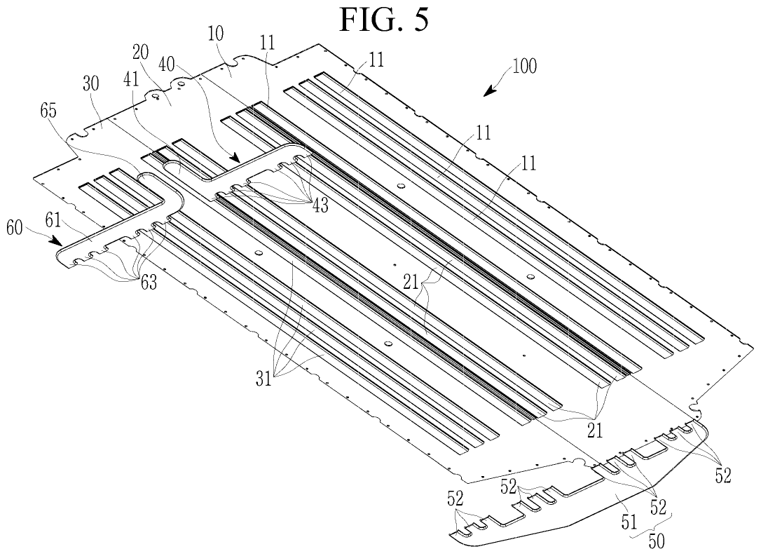

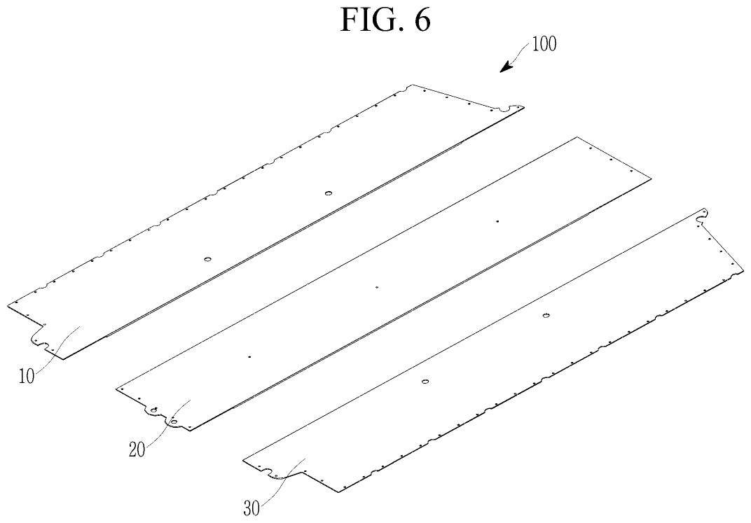

FIG. 3 illustrates a schematic perspective view of a base plate according to an embodiment of the present disclosure, FIG. 4 illustrates a cross-sectional view taken along the line A-A of FIG. 3, FIG. 5 illustrates an exploded perspective view of the base plate shown in FIG. 3 showing a state in which a refrigerant supply guide, a distribution supply guide, and a refrigerant discharge guide are separated from the base plate, and FIG. 6 illustrates an exploded perspective view showing the base plate shown in FIG. 3 separated into first to third cooling plates.

In more detail with reference to FIG. 3 to FIG. 6, the base plate 100 may include a first cooling plate 10 in which a first cooling passage 11 protrudes (or extends), a second cooling plate 20 in which the second cooling passage 21 protrudes (or extends), and a third cooling plate 30 in which a third cooling passage 31 protrudes (or extends). The first to third cooling plates 10, 20, and 30 may be welded together on a same plane in a state in which edges are in contact with each other.

The first cooling plate 10 may constitute a portion of the base plate 100 and may be formed to have a plate shape to contact and support the lower portions of the battery modules 500 on the first surface, which is the upper surface.

The first cooling passage 11 for cooling the battery modules 500 may be formed on a second surface, which is a rear surface, of the first cooling plate 10.

The first cooling passage 11, which protrudes from the second surface of the first cooling plate 10, may be formed to circulate a refrigerant supplied by a refrigerant supply guide 40, to be described later.

The first cooling passage 11 may include a plurality of cooling passages formed on the second surface of the first cooling plate 10 along a longitudinal direction thereof, and in the illustrated embodiment, four passages may be formed so that the refrigerant is movable therethrough.

Although the first cooling passage 11 is illustratively described as being formed as four passages, the present disclosure is not necessarily limited thereto, and any suitable number of first cooling passages 11 may protrude from the second surface such that a sufficient amount of refrigerant for cooling the battery modules 500 is moved corresponding to a length and width of the first cooling plate 10.

A second cooling plate 20 may be coupled to a side surface of the first cooling plate 10.

The second cooling plate 20 is formed with a similar length and width as that of the first cooling plate 10 and may be coupled with one edge in contact with one edge of the first cooling plate 10.

Herein, the first cooling plate 10 and the second cooling plate 20 may be welded in a state in which edges are in contact with each other. Thus, the first cooling plate 10 and the second cooling plate 20 may be connected to form an integrated bottom plate.

The second cooling passage 21 for cooling the battery modules 500 may be formed on a second surface, which is a rear surface, of the second cooling plate 20.

The first cooling passage 21 may include a plurality of second cooling passages 21 that protrude from the second surface of the first cooling plate 10, some of which may be connected to the refrigerant supply guide 40, and the others of which may be connected to the refrigerant discharge guide 60.

For example, the second cooling passage 21 may be formed such that a refrigerant is introduced and circulated through the refrigerant supply guide 40, and the refrigerant that has been circulated is discharged to the outside through the refrigerant discharge guide 60.

The second cooling passage 21 may include a plurality of cooling passages formed on the second surface of the second cooling plate 20 along a longitudinal direction thereof, and in the illustrated embodiment, four passages may be formed so that the refrigerant is movable therethrough.

Although the second cooling passage 21 is illustratively described as being formed as four passages, the present disclosure is not necessarily limited thereto, and any suitable number of first cooling passages may protrude from the second surface such that a sufficient amount refrigerant for cooling the battery modules 500 is moved corresponding to a length and width of the second cooling plate 20.

A third cooling plate 30 may be coupled to a side surface of the second cooling plate 20.

The third cooling plate 30 is formed with a similar length and width as that of the second cooling plate 20 and may be coupled with one edge in contact with one edge of the second cooling plate 20.

Herein, the second cooling plate 20 and the third cooling plate 30 may be welded in a state in which edges are in contact with each other. Thus, the second cooling plate 20 and the third cooling plate 30 may be connected to form an integrated bottom plate.

For example, the first cooling plate 10, the second cooling plate 20, and the third cooling plate 30 are welded together with edges in contact with each other such that the base plate 100 forms an integrated bottom plate.

As described above, the refrigerant supply guide 40, the distribution supply guide 50, and the refrigerant discharge guide 60 may be installed on the base plate 100, and thus, a refrigerant may circulate through the first to third cooling passages 31.

The refrigerant supply guide 40 may include a supply guide body 41 covering portions of the first cooling plate 10 and the second cooling plate 20, and an inlet protrusion 42 and a supply protrusion 43 protrude from the supply guide body 41.

The supply guide body 41 may be installed to extend in a width direction of the first cooling plate 10 to cover portions of the first cooling plate 10 and the second cooling plate 20 and to allow a refrigerant to move therethrough.

The inlet protrusion 42 may protrude from one side of the supply guide body 41 so that the refrigerant flows into the supply guide body 41.

For example, the inlet protrusion 42 may protrude from a side surface of the supply guide body 41 to be connected to a refrigerant supply source and to receive the refrigerant.

The supply protrusion 43 may protrude from a second side surface of the supply guide body 41 to supply a refrigerant to portions of the first cooling passage 11 and the second cooling passage 21. A plurality of supply protrusions 43 may protrude from the side of the supply guide body 41 to be connected to the first cooling passage(s) 11 and the second cooling passage(s) 21.

The refrigerant supplied by the refrigerant supply guide 40, configured as described above, may be supplied to portions of the first cooling passage 11 and the second cooling passage 21 to move toward the distribution supply guide 50.

The distribution supply guide 50 may be installed in the base plate 100 such that the refrigerant supplied through the refrigerant supply guide 40 circulates through the first to third cooling passages 31.

For example, the distribution supply guide 50 may extend in the width direction of the base plate 100, and may include, therein, a distribution guide body 51 through which the refrigerant is moved, and a plurality of distribution protrusions 52 protruding from a side surface of the distribution guide body 51 and connected to the first cooling passage 11, the second cooling passage 21, and the third cooling passage 31.

The distribution guide body 51 may extend in a width direction of the base plate 100 and may be installed at an edge of the second surface of the base plate 100 to be connectable to each of the first to third cooling passages 31.

The distribution protrusions 52, which protrude from the side surface of the distribution guide body 51, may protrude from the side of the distribution guide body 51 in a same number as a number of the first to third cooling passages to be connected to each of the first to third cooling channels 11, 21, and 31 in a one-to-one configuration.

As described above, the distribution supply guide 50 may be connected by the refrigerant supply guide 40 by portions of the first cooling passage 11 and the second cooling passage 21 and, thus, may be installed to receive the refrigerant and to distribute and supply the refrigerant in a direction of the refrigerant discharge guide 60.

For example, the distribution supply guide 50 may be connected to (e.g., may be in fluid communication with) the refrigerant supply guide 40 by (or through) portions of the first cooling passage 11 and the second cooling passage 21 to receive the refrigerant, and the supplied refrigerant may be distributed to the refrigerant discharge guide 60 connected to remaining portions of the second cooling passage 21 and the third cooling passage 31.

Accordingly, the refrigerant circulates between the first to third cooling passages between the refrigerant supply guide 40, the distribution supply guide 50, and the refrigerant discharge guide 60 on the second surface, which is the lower surface of the base plate 100, and thus, effective cools the battery modules 500.

A portion of the refrigerant discharge guide 60 may extend in a width direction of the third cooling plate 30 to cover a portion of the second surface of the second cooling plate 20.

Accordingly, the refrigerant discharge guide 60 may discharge and guide the refrigerant flowing through portions of the third cooling passage 31 and the second cooling passage 21 to the outside.

The refrigerant discharge guide 60 may extend in the width direction of the third cooling plate 30 such that a portion thereof covers portions of the second surface of the second cooling plate 20, and may include, therein, a discharge guide body 61 through which the refrigerant flows, a connection protrusion 63 protruding from a first side of the discharge guide body 61 and connected to a portion of the second cooling passage 21 and the third cooling passage 31 through which the refrigerant flows, and a discharge protrusion 65 protruding from a second side of the discharge guide body 61 to discharge the refrigerant to the outside.

The discharge guide body 61 may extend in the width direction of the third cooling plate 30 and may be installed to cover a portion of the second cooling plate 20 together. For example, the discharge guide body 61 may be installed such that a portion thereof extends to cover a portion of the second cooling plate 20 together as well as while covering the third cooling plate 30 in the width direction thereof.

The connection protrusion 63 may protrude such that a first side of the discharge guide body 61 protrudes and is connected to a portion of the second cooling passage 21 and the third cooling passage 31 to allow the refrigerant to flow therein and may be connected such that the refrigerant discharged from the distribution supply guide 50 is discharged to the outside.

The discharge protrusion 65 may protrude from a second side of the discharge guide body to discharge the refrigerant to the outside.

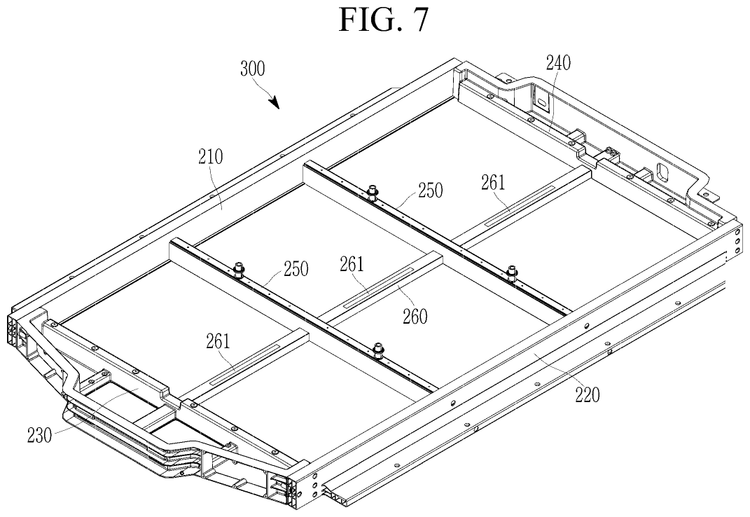

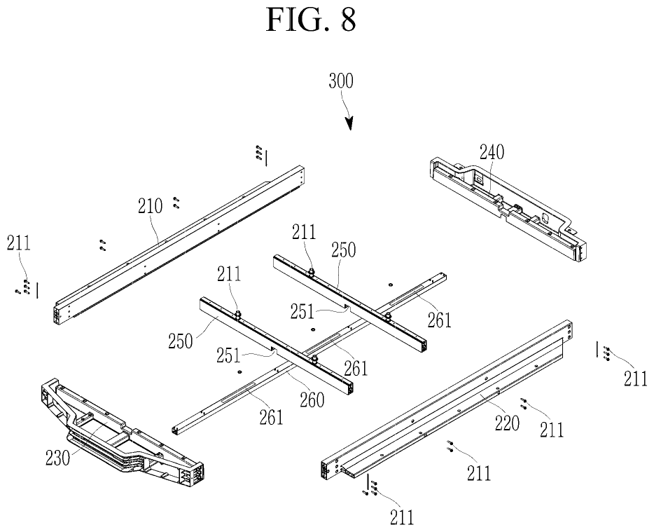

FIG. 7 illustrates a schematic perspective view of a frame portion according to an embodiment of the present disclosure, and FIG. 8 illustrates an exploded perspective view of the frame portion shown in FIG. 7.

As illustrated in FIG. 7 and FIG. 8, the frame portion 300 may include a first side frame 210 and a second side frame 220, a first end frame 230 and a second end frame 240 connecting the first side frame 210 and the second side frame 220 to each other, and a first reinforcement bar 250 and a second reinforcement bar 260.

The first side frame 210 may be coupled to a first edge of the base plate 100 and may be installed to support a first side of the battery modules 500.

The second side frame 220 may be coupled to a second edge of the base plate 100 and may be installed to support a second side of the battery modules 500.

The first end frame 230 may be installed to connect (e.g., extend between) first ends of each of the first side frame 210 and the second side frame 220.

For example, a first end of the first end frame 230 may be connected to a first end of the first side frame 210 by a fastening member 211, and a second end thereof may be connected to a first end of the second side frame 220 by the fastening member 211.

The second end frame 240 may be installed to connect (e.g., extend between) second ends of each of the first side frame 210 and the second side frame 220.

For example, a second end of the second end frame 240 may be connected to a first end of the first side frame 210 by the fastening member 211, and a second end thereof may be connected to a second end of the second side frame 220 by the fastening member 211.

A first or second reinforcement bar 250 or 260 may be connected at an inside of where the first or second side frame 210 or 220 and the first or second end frame 230 or 240 are connected to each other by the fastening member 211.

The first and second reinforcement bars 250 and 260 may be installed in a state of crossing each other and may divide the inside of the frame portion 300 into a plurality of spaces so that the battery modules 500 may be accommodated in a properly arranged state.

The first reinforcement bar 250 may have a first end connected to a side surface of the first side frame 210 by a fastening member and a second end connected to a side surface of the second side frame 220 by a fastening member.

A plurality of first reinforcement bars 250 may be installed to be spaced apart from each other at equal intervals between the first side frame 210 and the second side frame 220.

The second reinforcement bar 260 may have a first end connected to a side surface of the first end frame 230 by the fastening member 211 and a second end connected to the second end frame 240 by the fastening member 211.

The second reinforcement bar 260 may be installed in a state of crossing the first reinforcement bar 250. For example, a coupling groove 251 may be formed in the first reinforcement bar 250 at a position at where the second reinforcement bar 260 crosses.

Accordingly, the first reinforcement bar 250 and the second reinforcement bar 260 may be installed in a state of crossing each other to form a plurality of partitioned spaces such that the battery modules 500 are inserted into the frame portion 300.

An insertion groove 261 for inserting a cell supervising circuit (CSC) may be formed in the second reinforcement bar 260. A plurality of insertion grooves 261 may be formed in the second reinforcement bar 260 so that a plurality of cell supervising circuit boards may be inserted and fixed.

Spaces between a plurality of frames constituting the frame portion 300 may be sealed by a sealing member 270.

The sealing member 270 may be installed to enable stable sealing to prevent inflow of external foreign substances at the assembly position in a process of assembling the frames constituting the frame portion 300 using the fastening member 211.

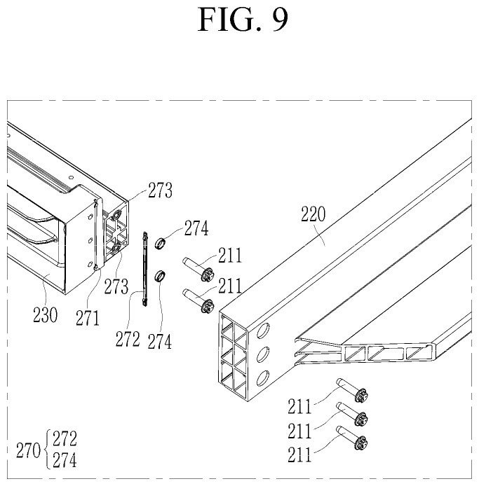

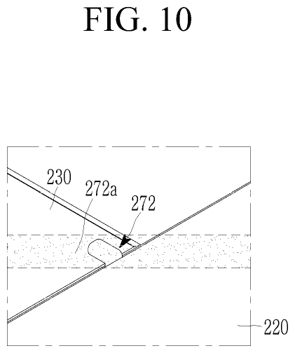

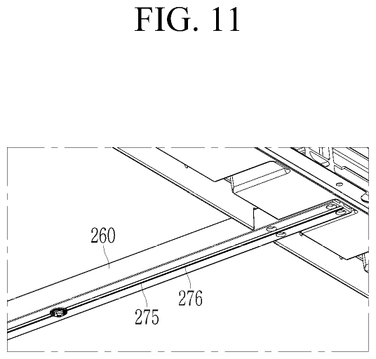

FIG. 9 illustrates a exploded perspective view showing a state in which a sealing member is installed inside a frame portion according to an embodiment of the present disclosure, FIG. 10 schematically illustrates a bent portion formed at an upper portion of a first sealer of the sealing member shown in FIG. 9 to be fixed to an upper cover by an adhesive, and FIG. 11 illustrates a exploded perspective view showing a state in which an adhesive groove is formed on a lower surface of a frame portion and an adhesive is applied to the adhesive groove according to an embodiment of the present disclosure.

With reference to FIG. 9 to FIG. 11, the sealing member 270 may include a first sealer 272 inserted into the inlet groove 271 formed on a surface between the plurality of frames, and a second sealer 274 inserted into a fastening hole 273 formed in the frames such that the fastening member is coupled thereto.

The inlet groove 271 may be formed on any one surface of the frames facing each other and may be formed at one edge of cross-sections of the frames.

The inlet groove 271 may be formed to have a long length in the vertical direction at an adjacent position where a fastening hole (e.g., a fastening opening) 273 is formed at an edge of one end of the frames.

A first sealer 272 may be inserted into the inlet groove 271.

The first sealer 272 may be formed with a long straight length corresponding to a length of the inlet groove 271 and may be inserted to seal between the frames constituting the frame portion 300.

The first sealer 272 may be made of a rubber material, and a portion of the first sealer 272 may protrude out of the inlet groove 271 to contact the surface of the frame in the state of being inserted into the inlet groove 271 and may seal between the frames.

A bent portion 272a may be formed at an upper portion of the first sealer 272 to be in contact with an upper surface of the frames.

A portion of the bent portion 272a may be bent such that the frame comes into contact with the upper surface in a state where the first sealer 272 is inserted into the inlet groove 271 and may be contact-fixed to an inner surface of the upper cover 400.

For example, the upper cover 400 may be fixed with an inner surface in contact with the surface of the bent portion 272a in a process of being fixed to cover an upper portion of the frame portion 300.

An adhesive may be applied to the inner surface of the upper cover 400 at a position in contact with the bent portion 272a, and thus, may stably fix the upper cover 400.

The second sealer 274 may have a through hole through which the fastening member 211 extends, to be inserted into the fastening hole 273 at a position between the frames.

For example, the second sealer 274 may be formed to have a ring shape with a through hole such that the fastening member 211 extends through the through hole to be fastened to the frame.

A number of second sealers 274 corresponding to a number of fastening members 211 may be inserted into positions where the fastening members 211 are fastened.

The second sealer 274 is made of the same rubber material as that of the first sealer 272 and can be inserted at a position where the fastening member 211 is fastened to provide stable sealing action so that foreign materials do not inflow.

An adhesive groove 275 may be formed on a lower surface of the frame portion 300.

The adhesive groove 275 may be formed on surfaces of the first and second end frames 230 and 240, the first and second reinforcement bars 250 and 260, and the first and second side frames 210 and 220 constituting the frame portion 300.

An adhesive 276 may be applied to the adhesive groove 275.

A portion of the adhesive 276 may protrude out of the adhesive groove 275 in a state of being inserted into the adhesive groove 275 and, thus, may further provide a fixing force to enable more stable coupling during a coupling process of the base plate 100. For example, the base plate 100 may be more stably fixed to the frame portion 300 by the fastening member 211 and the adhesive 276.

As described above, the battery pack according to the present embodiment may be assembled by using a fastening member, such as a bolt or a screw, and a sealing member may be inserted into the assembly position, and thus, robust assembly and stable assembly without inflow of foreign substances are possible.

In addition, the cooling line may be installed in an integrated state on the base plate on which a plurality of battery modules are seated, and thus, stable cooling of the battery modules may be possible, thereby further improving the stability.

In addition, the base plate 100, the frame portion 300, and the upper cover 400 are each formed of an aluminum material and assembled by using a fastening member 211, and thus, it is easy to disassemble and assemble so easy design changes are possible and action may be taken quickly in response to errors.

As described above, the frame portion 300 may be partitioned into a plurality of spaces (e.g., partition spaces) by the first and second side frames 210 and 220, the first and second end frames 230 and 240, and the first and second reinforcement bars 250 and 260, and the battery modules 500 may be inserted into the partition spaces.

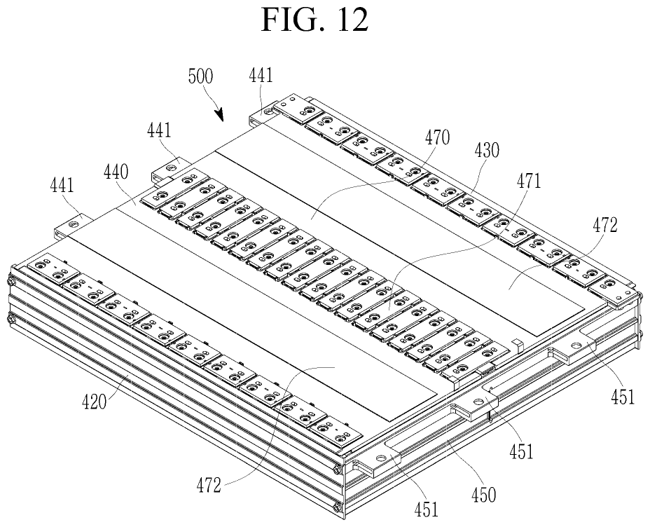

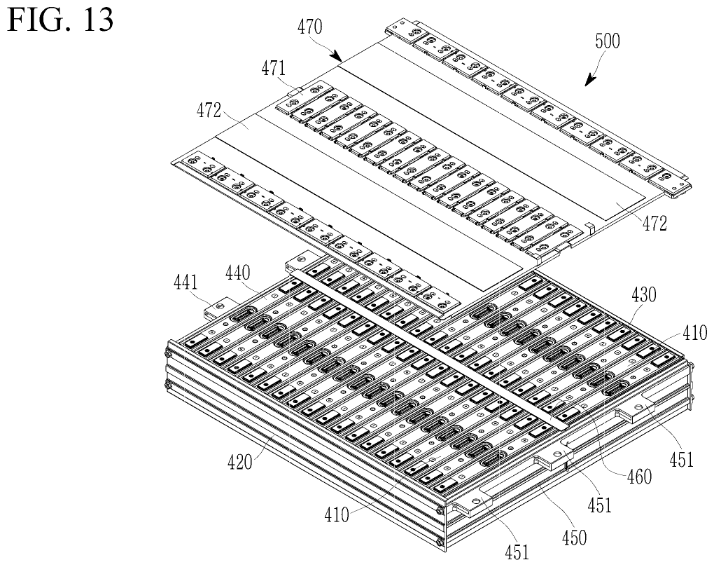

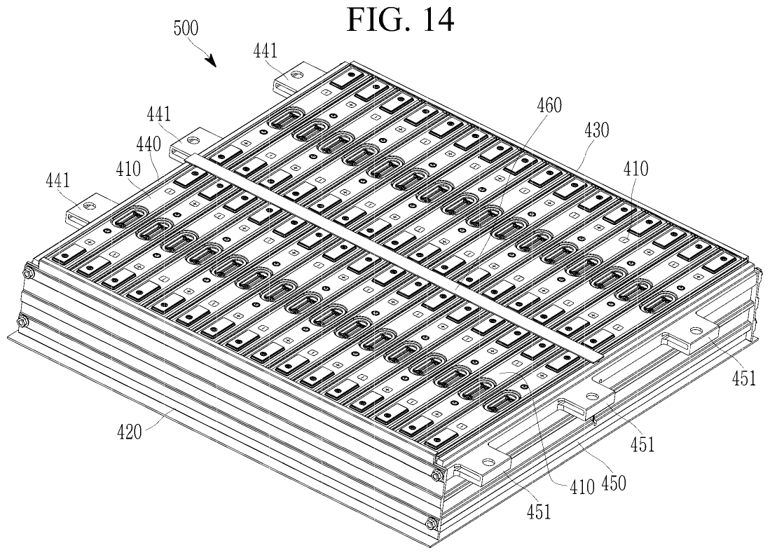

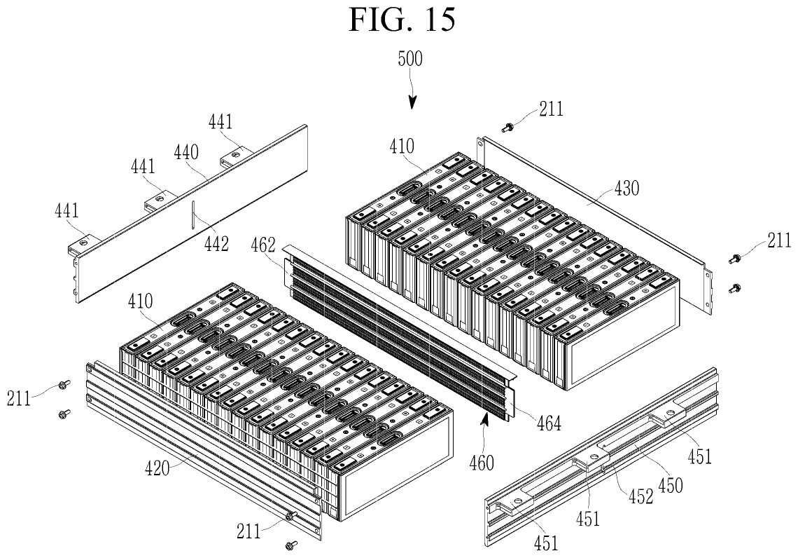

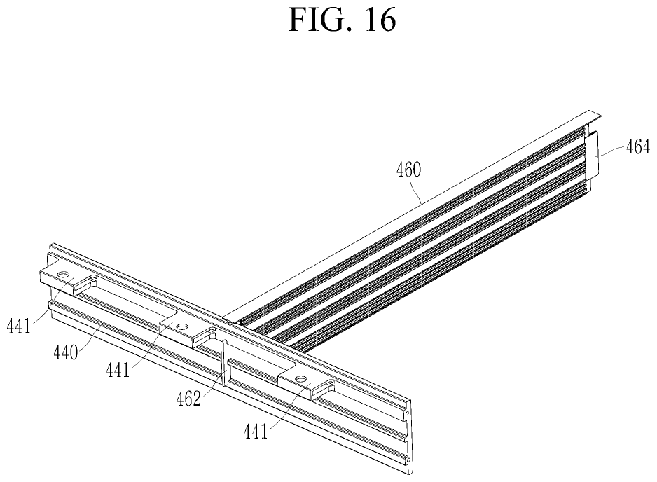

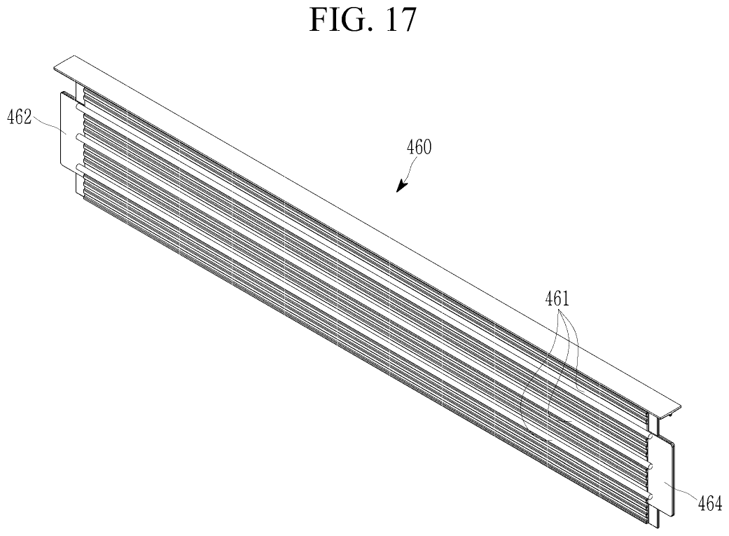

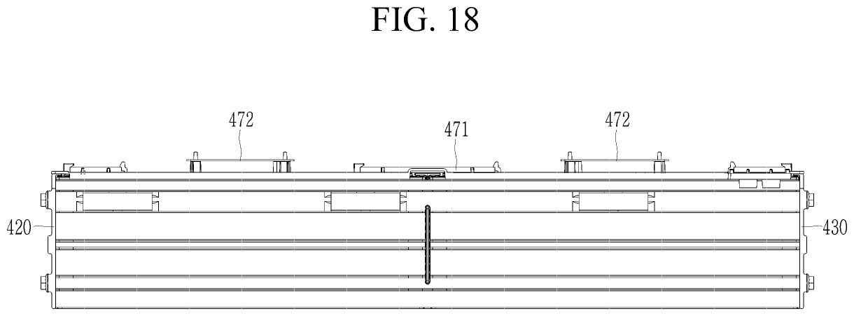

FIG. 12 illustrates a schematic perspective view of a battery module according to an embodiment of the present disclosure, FIG. 13 illustrates an exploded perspective view showing a state in which an upper plate of the battery module shown in FIG. 12 is separated, FIG. 14 illustrates a perspective view showing a state in which an upper plate of the battery module shown in FIG. 12 is removed, FIG. 15 illustrates a perspective view showing a state in which an upper plate of the battery module shown in FIG. 12 is removed, FIG. 16 illustrates a schematic perspective view showing coupling of an insulating plate and a first end plate according to an embodiment of the present disclosure, FIG. 17 illustrates a schematic perspective view of the insulating plate shown in FIG. 16, and FIG. 18 illustrates a state in which a gas tunnel portion is formed in the battery module according to an embodiment of the present disclosure.

As illustrated in FIG. 12 to FIG. 18, according to an embodiment of the present disclosure, the battery modules 500 may include a first side plate 420 supporting a first side of a plurality of battery cells 410, a second side plate 430 supporting a second side of the battery cells 410, a first end plate 440 having opposite ends connected to a first end of each of the first side plate 420 and the second side plate 430 by the fastening member 211, a second end plate 450 having opposite ends connected to a second end of each of the first side plate 420 and the second side plate 430 by the fastening member 211, and an insulating plate 460 coated with an adhesive 461 fixed to side surfaces of the battery cells and having a first end connected to a side surface of the first end plate 440 and an opposite a second end connected to a side surface of the second end plate 450.

The first side plate 420 may be installed to support a first side of the battery cells 410.

The first side plate 420 may be supported in a state of being in surface contact with a side surface of the battery cells 410. Herein, a surface of the first side plate 420 in surface contact with the battery cells 410 may be coated with insulation. Thus, the battery cells 410 may be stably accommodated inside the frame portion 300 in an electrically insulated state.

The second side plate 430 may be installed to support a second side of the battery cells 410.

The second side plate 430 may be supported in a state of being in surface contact with a side surface of the battery cells 410. Herein, a surface of the second side plate 430 in surface contact with the battery cell 410 may be coated with insulation. Accordingly, the battery modules 500 may be installed in an electrically insulated state between the first side plate 420 and the second side plate 430.

The first end plate 440 may be installed to connect first ends of the first side plate 420 and the second side plate 430 to each other.

For example, a first end of the first end plate 440 may be connected to a first end of the first side plate 420 by a fastening member 211, and a second end thereof may be connected to a first end of the second side plate 430 by the fastening member 211.

The second end plate 450 may be installed to connect second ends of the first side plate 420 and the second side plate 430 to each other.

For example, a first end of the second end plate 450 may be connected to a second end of the first side plate 420 by a fastening member 211, and a second end thereof may be connected to a second end of the second side plate 430 by the fastening member 211.

A first mount protrusion 441 fixed to the upper cover 400 by a fastening member may protrude from an upper edge of the first end plate 440.

The first mount protrusion 441 may protrude to a side surface of the first end plate 440 where a fastening hole to which the fastening member 211 is coupled is formed, and a first side of the upper cover 400 may be stably coupled to an upper side of the frame portion 300.

A second mount protrusion 451 fixed to the upper cover 400 by a fastening member may protrude from an upper edge of the second end plate 450.

The second mount protrusion 451 may protrude to a side surface of the second end plate 450 where a fastening hole to which the fastening member 211 is coupled is formed, and a second side of the upper cover 400 may be stably coupled to an upper side of the frame portion 300.

The insulating plate 460 may be connected in an inside where the first and second side plates 420 and 430 and the first and second end plates 440 and 450 connected to each other by the fastening member 211.

The insulating plate 460 may have a first end connected to a side surface of the first end plate 440 and a second end connected to a side surface of the second end plate 450.

To this end, a first coupling hole 442 to which a first end of the insulating plate 460 is fixed may be formed on a side surface of the first end plate 440. In addition, a second coupling hole 452 to which a second end of the insulation plate 460 is fixed may be formed on a side surface of the second end plate 450.

The insulating plate 460 may have a first end from which a first coupling protrusion 462 that is inserted and fixed into a first coupling hole 442 protrudes, and a second end from which a second coupling protrusion 464 that is inserted and fixed into the second coupling hole 452 protrudes.

An adhesive 461 may be applied to opposite surfaces of the insulating plate 460 to be fixed to a side surface of the battery module 500.

The adhesive 461 is applied to each of the opposite side surfaces of the insulating plate 460, and thus, a fixing force may be provided so that the battery modules 500 accommodated inside the frame portion 300 are stably positioned on a side surface of the insulating plate 460.

A plurality of bus bars 471 installed to be electrically connected to terminals of the battery cells 410 may be installed in the upper plate 470.

The bus bars 471 may be installed on the upper cover 400 in a state of being disposed in the first direction to be electrically connected to the terminals of the battery cells 410 positioned in the first direction (e.g., the z-axis direction) inside the frame portion 300.

A gas tunnel portion 472 may be installed (or formed) on a side surface of the bus bar 471.

The gas tunnel portion 472 may be installed on the upper cover 400 to discharge gas generated during a cell event caused by an abnormal operation of the battery modules 500 to the outside.

The gas tunnel portion 472 is formed with a long length along a longitudinal direction of the upper cover 400 between a plurality of bus bars 471, and in the illustrated embodiment, a pair of gas tunnel portion 472 may be installed in the upper cover 400 with the bus bars 471 therebetween.

As such, the gas tunnel portion 472 is installed in the upper cover 400, and thus, gas may be smoothly discharged to the outside in an abnormal operating state of the battery modules 500 to prevent an abnormal explosion or the like from occurring.

As described above, the battery modules 500 according to embodiments of the present disclosure are assembled to be disassemblable and assemblable by fastening of a fastening member instead of by using a welding process in an assembly process, and thus, a structure of the battery modules may be simplified and a design thereof may be easily changed.

In addition, a cooling circuit is formed outside the base plate supporting the battery module, and thus, an electrical flow path may not be formed during an operation of the battery modules.

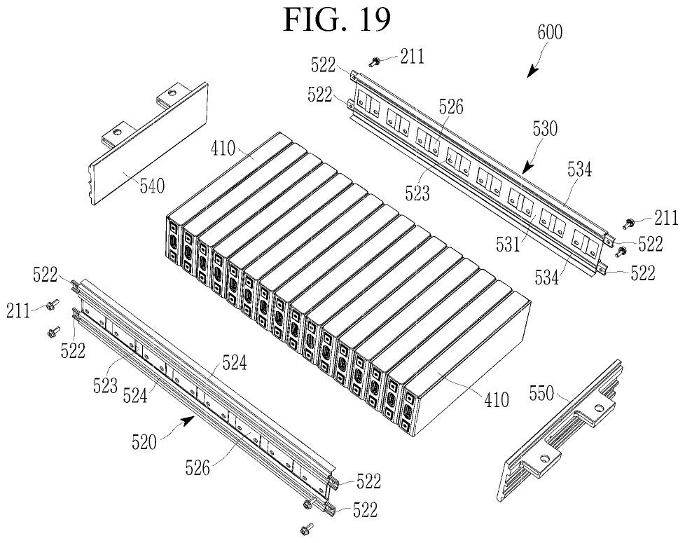

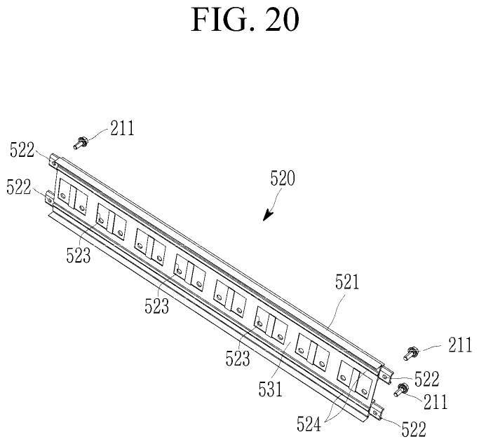

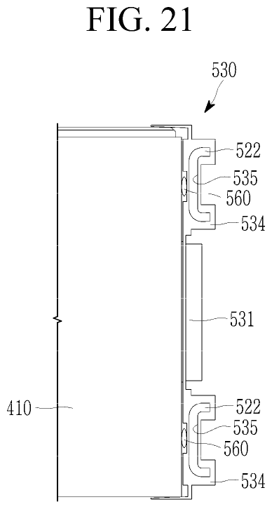

FIG. 19 illustrates a schematic exploded perspective view of a battery module according to an embodiment of the present disclosure, FIG. 20 illustrates a schematic perspective view of a first side portion shown in FIG. 19, and FIG. 21 illustrates a schematic side view showing a state in which an insert bar of the battery module shown in FIG. 19 is installed.

As illustrated in FIG. 19 to FIG. 21, the battery module 600 according to an embodiment of the present disclosure includes a first side portion 520 supporting a first side of the battery cells 410, a second side portion 530 supporting a second side of the battery cells 410, a first end portion 540 having opposite ends connected to a first end of each of the first side portion 520 and the second side portion 530 by the fastening member 211, a second end portion 550 having opposite ends connected to a second end of each of the first side portion 520 and the second side portion 530 by the fastening member, and an insert bar 522 inserted into the first side portion 520 and the second side portion 530.

The first side portion 520 may be coupled to a first edge of the base plate 100 and may be installed to support a first side of the battery cells 410.

The first side portion 520 may be supported in a state of being in surface contact with a side surface of the battery cells 410.

The first side portion 520 may be formed of a plastic material to support a first side of the battery cells 410 in an insulated state.

The first side portion 520 may include a first plate 521 having a plurality of through holes 523 into which terminals of the battery cells 410 are inserted, and a first insert portion 524 that protrudes from a side surface of a first plate 521 and has an insertion hole into which an insert bar 522 is inserted.

The first plate 521 may be supported in surface contact with a side surface of the battery cells 410 and may be formed of a plastic material to support a first side of the battery cells 410 in an insulated state.

The first plate 521 may be formed with a plurality of through holes 523 along a longitudinal direction, and terminals of the battery cells 410 may be installed to be inserted into the through holes 523. Thus, the battery cells 410 may be positioned such that terminals face the through holes 523 in the first plate 521.

A first insert portion 524, into which an insert bar 522 for reinforcement is inserted, may protrude from the first plate 521.

The first insert portion 524 may be formed to protrude from the side surface of the first plate 521 in a longitudinal direction, and an insertion hole into which the insert bar 522 is inserted may be formed.

The insert bar 522 has a length corresponding to a length of the first plate 521 to be inserted into the first insert portion 524 and may be formed of a metal material to ensure durability.

The second side portion 530 may be coupled to a second edge of the base plate 100 and may be installed to support a second side of the battery cells 410.

The second side portion 530 may be supported in a state of being in surface contact with a side surface of the battery cells 410.

The second side portion 530 may be formed of a plastic material to support a first side of the battery cells 410 in an insulated state.

A second insert portion 534 into which an insert bar 522 for reinforcement is inserted may protrude from the second plate 531.

The second insert portion 534 may be formed to protrude from the side surface of the second plate 531 in a longitudinal direction, and an insertion hole into which the insert bar 522 is inserted may be formed.

The insert bar 522 is formed to a length corresponding to a length of the second plate 531 to be inserted into the second insert portion 534 and may be formed of a metal material to ensure durability.

A bus bar 526 electrically connected to terminals of the battery cells 410 may be installed in each of the first plate 521 and the second plate 531.

Each of the first plate 521 and the second plate 531 may be coated with an adhesive 560 at a position in surface contact with the battery cells 410.

The adhesive 560 may be applied to a surface of each of the first plate 521 and the second plate 531 in a longitudinal direction, and thus, a fixing force of each of the first plate 521 and the second plate 531 installed on side surfaces of the battery cells 410 may be improved.

While the present disclosure has been described in connection with what is presently considered to be practical embodiments, it is to be understood that the present disclosure is not limited to the disclosed embodiments but is intended to cover various modifications and equivalent arrangements included within the spirit and scope of the appended claims and their equivalent.

Description of Some Reference Numerals

| | | | |
|---|---|---|---|
| 10 | first cooling plate | 11 | first cooling passage |
| 20 | second cooling plate | 21 | second cooling passage |
| 30 | third cooling plate | 31 | third cooling passage |
| 40 | refrigerant supply guide | 41 | supply guide body |
| 42 | inflow protrusion | 43 | supply protrusion |
| 50 | distribution supply guide | 51 | distribution guide body |
| 52 | distribution protrusion | 60 | refrigerant discharge guide |
| 61 | discharge guide body | 63 | connection protrusion |
| 65 | discharge | 100 | base plate |
| 200 | lower cover | 210 | first side frame |
| 220 | second side frame | 230 | first end frame |
| 240 | second end frame | 250 | first reinforcement bar |
| 260 | second reinforcement bar | 270 | sealing member |
| 271 | inlet groove | 272 | first sealer |
| 272a | bent portion | 273 | fastening hole |
| 274 | second sealer | 275 | adhesion groove |
| 276 | adhesive | 300 | frame portion |
| 400 | top cover | 410 | battery cell |
| 420 | first side plate | 430 | second side plate |
| 440 | first end plate | 441 | first mount protrusion |
| 442 | first coupled | 450 | second end plate |
| 451 | second mount protrusion | 452 | second coupling hole |
| 460 | insulation plate | 471 | bus bar |
| 472 | gas tunnel portion | 500 | battery module |
| 520 | first side portion | 521 | first plate |
| 522 | insert bar | 523 | through hole |
| 524 | first insert portion | 526 | bus bar |
| 530 | second side portion | 531 | second plate |
| 534 | second insert portion | 540 | first end portion |
| 550 | second end portion | | |

What is claimed is:

1. A battery pack comprising:
a base plate having a first surface for supporting a plurality of battery modules and comprising a cooling passage configured to receive a refrigerant;
a lower cover covering a second surface of the base plate;
a frame portion on the first surface of the base plate and comprising a plurality of frames coupled to each other by a fastening member;
a sealing member sealing spaces between the frames of the frame portion; and
an upper cover covering an upper portion of the frame portion.

2. The battery pack of claim 1, wherein the cooling passage is on a second surface of the base plate that is opposite to the first surface of the base plate.

3. The battery pack of claim 2, wherein the base plate comprises a plurality of cooling plates having edges that are welded to each other.

4. The battery pack of claim 3, wherein the base plate further comprises:
a first cooling plate having a second surface from which a first cooling passage protrudes;
a second cooling plate having a first edge coupled to a first edge of the first cooling plate and a second surface from which a second cooling passage protrudes; and
a third cooling plate having a first edge coupled to a second edge of the second cooling plate and a second surface from which a third cooling passage protrudes.

5. The battery pack of claim 4, wherein the first to third cooling passages are each formed as a plurality in the first to third cooling plates, respectively.

6. The battery pack of claim 5, further comprising a refrigerant supply guide at a first side of the second surface of the base plate to guide supply of the refrigerant to portions of the first cooling passage and the second cooling passage.

7. The battery pack of claim 6, wherein the refrigerant supply guide is configured to supply the refrigerant to portions of the first cooling passage of the first cooling plate and the second cooling passage of the second cooling plate.

8. The battery pack of claim 7, wherein the refrigerant supply guide extends in a width direction of the first cooling plate such that a portion thereof covers a portion of the second surface of the second cooling plate to supply the refrigerant to portions of the first cooling passage and the second cooling passage.

9. The battery pack of claim 8, wherein the refrigerant supply guide comprises:
a supply guide body extending in the width direction of the first cooling plate to cover portions of the first cooling plate and the second cooling plate to move a refrigerant therein;
an inlet protrusion protruding from a first side of the supply guide body and through which the refrigerant flows; and
a plurality of supply protrusions protruding from a second side of the supply guide body to supply the refrigerant to portions of the first cooling passage and the second cooling passage.

10. The battery pack of claim 8, further comprising a distribution supply guide installed at a second side of the second surface of the base plate and configured to distribute the refrigerant supplied by the refrigerant supply guide.

11. The battery pack of claim 10, wherein the distribution supply guide comprises:
a distribution guide body extending in a width direction of the base plate from the second side of the second surface of the base plate to move the refrigerant therein; and
a plurality of distribution protrusions protruding from a side surface of the distribution guide body to be connected to the first cooling passage, the second cooling passage, and the third cooling passage.

12. The battery pack of claim 11, further comprising a refrigerant discharge guide connected to some of the first cooling passages of the first cooling plate and the third cooling passage of the third cooling plate to guide discharge of the refrigerant to the outside on the second surface of the base plate.

13. The battery pack of claim 12, wherein the refrigerant discharge guide extends in a width direction of the first cooling plate such that a portion thereof covers a portion of the second surface of the second cooling plate to discharge and guide the refrigerant flowing through the third cooling passage and some of the second cooling passages to the outside.

14. The battery pack of claim 13, wherein the refrigerant discharge guide comprises:
a discharge guide body extending in a width direction of the third cooling plate such that a portion thereof covers a portion of the second surface of the second cooling plate to move the refrigerant therein;
a connecting protrusion protruding from a first side of the discharge guide body and connected to some of the second cooling passages and the third cooling passage to receive the refrigerant; and
a discharge protrusion protruding from a second side of the discharge guide body to discharge the refrigerant to the outside.

15. The battery pack of claim 1, wherein the sealing member comprises:
a first sealer in an inlet groove on any one surface between the frames; and
a second sealer in a position of a fastening hole in at least one of the frames to allow the fastening member to be coupled thereto.

16. The battery pack of claim 15, wherein the first sealer contacts a side surface of the frames by allowing a first side to be inserted into the inlet groove and a second side to partially protrude out of the inlet groove.

17. The battery pack of claim 15, wherein the first sealer has a linear shape in the inlet groove.

18. The battery pack of claim 17, wherein the first sealer has a bent portion that is bent to contact an upper surface of the frames at an upper end of the first sealer.

19. The battery pack of claim 18, wherein the bent portion of the first sealer is adhered to the upper cover by an adhesive member.

20. The battery pack of claim 17, wherein the second sealer has a through hole through which the fastening member extends to be inserted into the fastening hole at a position between the frames.

21. The battery pack of claim 17, wherein the second sealer has a round shape inserted into the fastening hole.

22. The battery pack of claim 1, wherein the frame portion comprises:
a first side frame coupled to a first edge of the base plate;
a second side frame coupled to a second edge of the base plate;
a first end frame having opposite ends connected to a first end of each of the first side frame and the second side frame by a fastening member;
a second end frame having opposite ends connected to a second end of each of the first side frame and the second side frame by a fastening member;
a plurality of first reinforcement bars having a first end connected to a side surface of the first side frame by a fastening member and a second end connected to a side surface of the second side frame by a fastening member; and
a plurality of second reinforcement bars having a first end connected to a side surface of the first end frame by a fastening member and a second end connected to the second end frame by a fastening member, the second reinforcement bars crossing the first reinforcement bars.

23. The battery pack of claim 22, wherein an adhesive groove is in a lower surface of the frame portion, and
wherein an adhesive for fixing the base plate is applied to the adhesive groove.

24. The battery pack of claim 1, further comprising a plurality of battery modules, each of the battery modules comprising:
a first side plate supporting a first side surface of a plurality of battery cells;
a second side plate supporting a second side surface of the battery cells;
a first end plate having opposite ends connected to a first end of each of the first side plate and the second side plate by a fastening member;
a second end plate having opposite ends connected to a second end of each of the first side plate and the second side plate by a fastening member;
an insulating plate having a first end connected to a side surface of the first end plate and a second end connected to a side surface of the second end plate and having an adhesive applied to opposite side surfaces of the battery cells; and
an upper plate covering an upper portion of the battery cells.

25. The battery pack of claim 24, wherein a first coupling hole to which a first end of the insulating plate is fixed is in a side surface of the first end plate, and
wherein a second coupling hole to which a second end of the insulating plate is fixed is in a side surface of the second end plate.

26. The battery pack of claim 25, wherein the insulating plate has a first end from which a first coupling protrusion that is inserted and fixed into a first coupling hole protrudes and a second end from which a second coupling protrusion that is inserted and fixed into the second coupling hole protrudes.

27. The battery pack of claim 26, wherein a surface of each of the first side plate and the second side plate in contact with the battery cells is coated with an insulating material.

28. The battery pack of claim 27, wherein a first mount protrusion fixed to the upper cover by a fastening member protrudes from an upper edge of the first end plate.

29. The battery pack of claim 28, wherein a second mount protrusion fixed to the upper cover by a fastening member protrudes from an upper edge of the second end plate.

30. The battery pack of claim 29, wherein the upper plate comprises:
a plurality of bus bars installed to be electrically connected to terminals of the battery cells; and
a gas tunnel portion formed between the bus bars in a longitudinal direction of the upper cover.

31. The battery pack of claim 1, further comprising a plurality of battery modules, each of the battery modules comprising:
a first side portion supporting a first side surface of a plurality of battery cells;
a second side portion supporting a second side surface of the battery cells;
a first end portion having opposite ends connected to a first end of each of the first side portion and the second side portion by a fastening member;
a second end portion having opposite ends connected to a second end of each of the first side portion and the second side portion by a fastening member; and
an insert bar inserted into the first side portion and the second side portion.

32. The battery pack of claim 31, wherein terminals of the battery cells face in a direction of the first side portion and the second side portion.

33. The battery pack of claim 32, wherein the first side portion and the second side portion are made of a plastic material.

34. The battery pack of claim 33, wherein the first side portion comprises:
a first plate having a plurality of through holes into which terminals of the battery cells are inserted; and
a first insert portion protruding from a side surface of the first plate and having an insertion hole into which the insert bar is inserted.

35. The battery pack of claim 34, wherein the first insert portion is at a first edge position and a second edge position with the through hole provided therebetween in the first plate.

36. The battery pack of claim 35, wherein a bus bar electrically connected to the terminals extending through the through hole is installed in the first side portion.

37. The battery pack of claim 36, wherein an adhesive is between the first plate and the battery cells.

38. The battery pack of claim 37, wherein the second side portion comprises:
a second plate having a plurality of through holes into which terminals of the battery cells are inserted; and
a second insert portion protruding from a side surface of the second plate and having an insertion hole into which the insert bar is inserted.

39. The battery pack of claim 38, wherein the second insert portion is formed at a first edge position and a second edge position with the through hole provided therebetween in the second plate.

40. The battery pack of claim 39, wherein a bus bar electrically connected to the terminal extending through the through hole is in the second side portion.

41. The battery pack of claim 40, wherein an adhesive is applied between the second plate and the battery cells.
